(19) United States
(12) Patent Application Publication
(10) Pub. No.: US 2025/0305613 A1
(43) Pub. Date: Oct. 2, 2025

(54) POWDER INJECTOR WITH QUICK COUPLING

(71) Applicant: Wagner International AG, Altstätten (CH)

(72) Inventors: René Schmid, Hinterforst (CH); Jan Breu, Oberegg (CH); Gilbert Lutz, Kriessern (CH)

(73) Assignee: Wagner International AG, Altstätten (CH)

(21) Appl. No.: 19/072,105

(22) Filed: Mar. 6, 2025

(30) Foreign Application Priority Data
Mar. 28, 2024 (EP) 24167251.8

(51) Int. Cl. F16L 37/56; B65G 53/16

(52) U.S. Cl. CPC F16L 37/56; B65G 53/16; B65G 2201/04

(57) ABSTRACT

The powder injector according to the invention with quick coupling comprises an injector housing (5), which has a powder inlet (12) and supply air inlets (5.15, 5.16, 5.17) and in which a drive nozzle (7) and a collection nozzle (8) are arranged. The powder injector additionally comprises a line connection block (6), which has connections (15, 16, 17) for supply air lines and the supply air outlets (6.15, 6.16, 6.17). The powder injector furthermore comprises a quick closure (9), by means of which the line connection block (6) can be fastened to the injector housing (5) and the supply air outlets (6.15, 6.16, 6.17) of the line connection block (6) can be connected to the supply air inlets (5.15, 5.16, 5.17) of the injector housing (5).

### TECHNICAL FIELD

The invention relates to a powder injector with quick coupling.

In order to coat a workpiece with coating powder or powder, in short, the powder is transported out of a powder storage container by means of a powder conveyor to a powder spray gun and is sprayed onto the workpiece there. The powder conveyor comprises a powder injector, which generates a negative pressure with the help of conveying air and thereby sucks the powder out of the powder storage container. In the injector, the mixture of conveying air and powder flows through a collection nozzle. Metering air is additionally admixed to the powder-conveying air mixture on the downstream side of the collection nozzle, in order to attain a defined total airflow.

### PRIOR ART

A pneumatically operated powder conveyor, by means of which coating powder can be conveyed out of a powder storage container, is known from the publication DE 10 2006 018 066 A1. The powder conveyor comprises an injector with an intake port for powder, a drive nozzle, a collection nozzle and a powder outlet. The injector additionally comprises a conveying air connection, via which it is supplied with conveying air, and a metering air connection, via which it is supplied with metering air. The hose, which is necessary for the transport of the powder to the powder spray gun, can be connected with the help of a cap nut. No fluidizing air connection is present in the case of this solution. In order to remove the collection nozzle, the cap nut has to first be loosened and has to then be removed together with the powder hose. Only then can the collection nozzle be pulled out of the injector housing. In order to clean the powder injector, the conveying air line has to first be removed from the conveying air connection, the metering air line has to then be removed from the metering air connection. And lastly, the cap nut has to be loosened and has to then be taken off together with the powder hose. A relatively large amount of hand movements are thus required, until the injector is prepared to such an extent that it can be cleaned.

### DESCRIPTION OF THE INVENTION

It is an object of the invention to specify a powder injector with quick coupling, in the case of which the supply air lines can be coupled and decoupled easily and quickly.

In the case of the powder injector according to the invention, the collection nozzle can advantageously be uninstalled from the injector housing in an easy and tool-free manner.

It is a further advantage in the case of the powder injector according to the invention with quick coupling that simultaneously with the supply air lines, the powder hose can also be coupled to the injector or can be decoupled from the injector. The cleaning time can be reduced even further thereby.

In the case of the powder injector according to the invention, a color change can advantageously be carried out particularly quickly.

It is sufficient when the line connection block is released from the injector housing with the help of the quick coupling, in order to also decouple all lines (powder line, conveying air line, fluidizing air line and/or metering air line) form the injector housing.

It is a further advantage of the invention that the cleaning of the powder injector can take place particularly quickly and easily.

The collection nozzle can also be removed from the powder injector with few hand movements and without the use of tools.

It is a further advantage in the case of the powder injector according to the invention that the hoses or lines, respectively (powder line, conveying air line, fluidizing air line and metering air line) are clearly arranged and that the system operator can see at a glance if the hoses are connected correctly.

The cleaning of the injector can take place manually or in an automated manner. For example, the powder lance can thus be flushed automatically. For this purpose, it can be brought into a cleaning station, where it is then cleaned automatically.

The object is solved by means of a powder injector with quick coupling with the features specified in patent claim 1.

The powder injector according to the invention with quick coupling comprises an injector housing, which has a powder inlet and supply air inlets and in which a drive nozzle and a collection nozzle are arranged. The powder injector additionally comprises a line connection block, which has connections for supply air lines and the supply air outlets. The powder injector furthermore comprises a quick closure, by means of which the line connection block can be fastened to the injector housing and the supply air outlets of the line connection block can be connected to the supply air inlets of the injector housing.

Advantageous further developments of the invention follow from the features specified in the dependent patent claims.

In the case of one embodiment of the powder injector according to the invention, the quick closure has a snap-in connection. The snap-in connection offers a more secure and more stable connection by means of the engagement of the parts.

In the case of a further embodiment of the powder injector according to the invention, the quick closure comprises a self-resetting closure clip. The closure clip is securely held in the engaged position, for example by means of a spring. The quick closure is resilient against impacts or vibrations or shaking of the powder injector and does not open independently. The closure clip is placed into the correct end position by means of the spring.

In the case of an additional embodiment of the powder injector according to the invention, the line connection block comprises a powder hose connection, which forms the powder outlet of the powder injector. This has the advantage that not only the air lines can be removed from the powder injector by means of the line connection block, but the powder hose can also be removed at the same time.

In the case of a further development of the powder injector according to the invention, one of the connections of the line connection block is provided for the connection of a hose for conveying air. The conveying air is used for conveying the powder.

In the case of another further development of the powder injector according to the invention, a further one of the connections of the line connection block is provided for the connection of a hose for metering air. This has the advantage that the conveying and metering air line can thus be removed in one step.

In the case of the powder injector according to the invention, it can additionally be provided that a further one of the connections of the line connection block is provided for the connection of a hose for fluidizing air. This has the advantage that the fluidizing air hose can thus also be removed with other supply air lines at the same time. Whether the line is formed as hose depends on the respective application. If this is not important, line and hose are used as synonyms.

In the case of an additional further development of the powder injector according to the invention, the connections are arranged on one side of the line connection block. This has the advantage that the lines can thus be connected and continued in a bundles manner on the same side. The handling with the lines is thus improved during connection and during removal. The lines can also be guided in a common hose. The lines are even better protected against contaminations and external stresses (bending) thereby.

In the case of a further development, the powder injector according to the invention has seals, which are arranged between the supply air outlets and the supply air inlets. It is thus ensured that no air can escape from the interface between injector housing and line connection block in the assembled state. A leakiness would have influence on the powder volume flow of the powder to be conveyed.

In the case of another further development of the powder injector according to the invention, the seals are formed as radially acting seals. The radially acting seals offer an improved sealing against temperatures and compressive stresses in the radial direction and are thus even more secure against leakiness. The radially acting seals can also be installed better and are held in a groove.

In the case of the powder injector according to the invention, it can additionally be provided that the line connection block has a guide and the injector housing has a counter piece matching the guide. This has the advantage that the line connection block can be attached to the injector housing easily, securely and with the correct orientation. The air connections thus match one another.

In the case of an advantageous further development, the powder injector according to the invention has a non-return valve, which is arranged in the injector housing downstream from the supply air inlet. It can be prevented by means of the non-return valve that powder gets into the supply air line. Powder in the supply air line is to be avoided because the powder in the supply air line can clog the supply air line. If the non-return valve were not present, powder could get all the way to the regulating valves in the control via the air line and could damage them.

In the case of the powder injector according to the invention, it can furthermore be provided that the injector housing comprises an upper housing part, a lower housing part and at least one connecting means, which connects the upper housing part and the lower housing part to one another. The connecting means also forms the axis of rotation for the closure clip and holds the closure clip.

The connecting means advantageously serves the purpose of establishing a releasable connection. The connecting means is preferably a mechanical connection between upper housing part and lower housing part. It can be, for example, a screw or a combination of threaded pin and nut.

The injector housing of the powder injector according to the invention is advantageously formed so that the collection nozzle can be pulled out of the injector housing when the line connection block is taken off. This has the advantage that the collection nozzle can be cleaned easily and/or can be checked for wear and can be replaced, if need be.

In the case of one embodiment of the powder injector according to the invention, an intake pipe is provided, which is connected to the powder inlet of the powder injector. A pipe surrounding the intake pipe and a fluidizing air line are additionally provided, wherein the fluidizing air line runs through the injector housing and opens out into the pipe. This has the advantage that the intake pipe is connected to the powder injector and the connecting point does not have to be cleaned. The cleaning of the powder injector is thus even more efficient.

In the case of a further embodiment of the powder injector according to the invention, the intake pipe has a thread on the outlet side and the injector housing has a matching counter thread. This has the advantage that the intake pipe can be securely connected directly to the injector housing without additional connecting elements.

In the case of an additional embodiment of the powder injector according to the invention, a fluidizing ring is present, which is connected to the pipe and which is provided to distribute fluidizing air in the powder supply. The fluidizing air is distributed optimally by means of the fluidizing ring at the powder inlet of the intake pipe and fluidizes the powder, so that the powder can be conveyed well via the powder injector.

Lastly, it is proposed to form the fluidizing ring so that it centers the intake pipe with respect to the pipe. This has the advantage that no further components are required for the centering. The fluidizing air is conveyed and distributed evenly to the fluidizing ring. The fluidizing air is thus evenly distributed in the region of the powder inlet of the intake pipe and the powder is optimally fluidized.

### BRIEF DESCRIPTION OF THE DRAWINGS

The invention will be further explained below with several exemplary embodiments on the basis of 16 figures.

FIG. 1 shows a first possible embodiment of a powder conveyor with a powder injector and a powder lance in a three-dimensional view.

FIG. 2 shows the first embodiment of the powder conveyor in the partly disassembled state in a three-dimensional view.

FIG. 3 shows the first embodiment of the powder conveyor in an exploded view.

FIG. 4 shows the first embodiment of the powder conveyor with the powder injector in the view from the bottom.

FIG. 5 shows the first embodiment of the powder conveyor with the powder injector in the view from the top.

FIG. 6 shows the first embodiment of the powder conveyor in the side view.

FIG. 7 shows the first embodiment of the powder conveyor with powder injector and powder lance in a first longitudinal section.

FIG. 8 shows the first embodiment of the powder conveyor in a second longitudinal section.

FIG. 9 shows the first embodiment of the powder conveyor in the view from the front.

FIG. 10 shows the first embodiment of the powder conveyor in a third longitudinal section.

FIG. 11 shows the powder injector in a three-dimensional view, wherein the line connection block is taken off the injector housing.

FIG. 12 shows the powder injector in the side view in the assembled state.

FIG. 13 shows the powder injector with a second embodiment of the line connection block in a three-dimensional view, wherein the line connection block is taken off the injector housing.

FIG. 14 shows the powder injector with the second embodiment of the line connection block in the side view in the assembled state.

FIG. 15 shows a system for the manual coating in a three-dimensional view, wherein the powder conveyor is lowered.

FIG. 16 shows the system for the manual coating in a three-dimensional view, wherein the powder conveyor is pulled up.

### WAYS FOR CARRYING OUT THE INVENTION

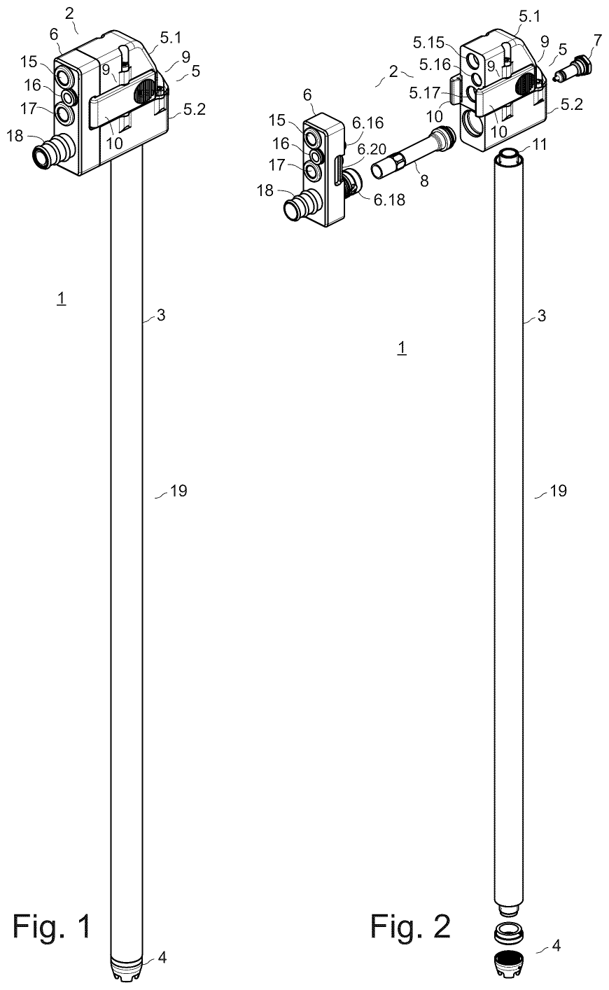

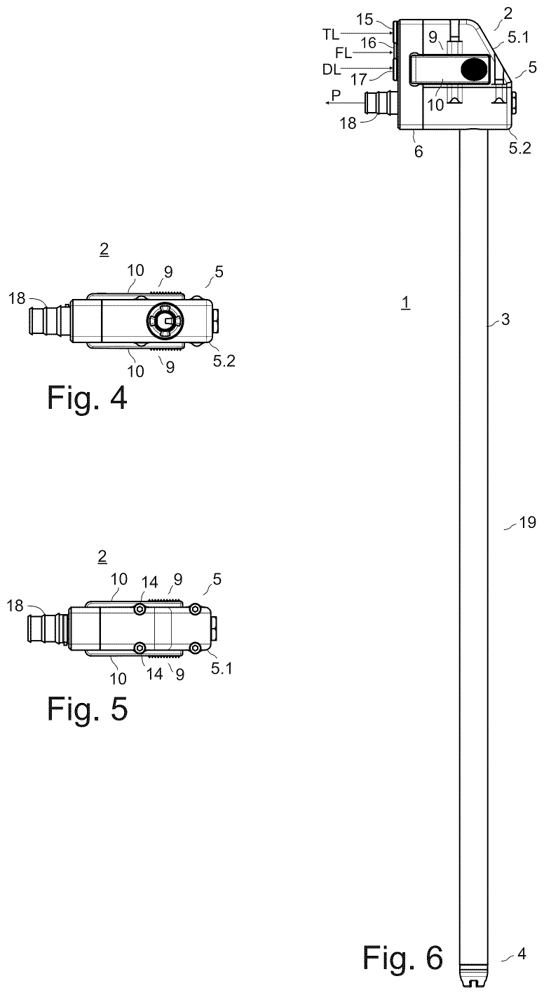

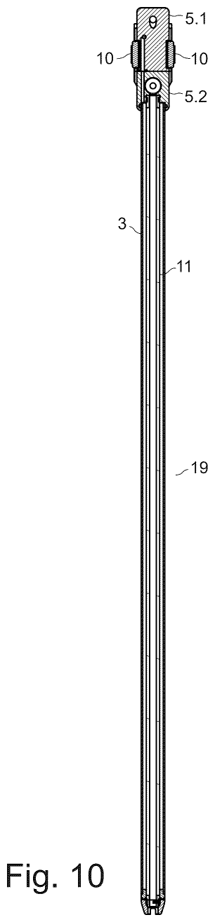

A first possible embodiment of a powder conveyor 1 is illustrated in various views and in various longitudinal sections in FIGS. 1 to 10. The powder conveyor 1 can be used to suck coating powder for example out of a powder reservoir (not shown in the figures) and to supply it to a powder applicator (likewise not shown in the figures). The powder reservoir can be a powder storage container, for example. The powder storage container can be a box, in which a plastic sack containing the coating powder is located.

The powder conveyor 1 comprises a powder injector 2 or injector, in short, and a powder lance 19, in order to suck the powder out of the storage container.

The powder injector 2 has an injector housing 5, which can be connected to a line connection block 6 via a quick closure 9. The injector 2 is shown in the assembled state in FIG. 1. The quick closure 9 comprises a first and a second closure clip 10, wherein the first closure clip 10 is arranged on the one side of the injector housing 5 and the second closure clip 10 is arranged on the other side of the injector housing 5. The two closure clips 10 are rotatably fastened to the injector housing 5 via a respective screw 14. Instead of the screw, a different connecting means can also be used, such as, for example, a combination of threaded pin and nut, wherein the threaded pin serves as axis of rotation.

Both closure clips 10 have a catch 10.2 on the front. When the two closure clips 10 are pressed together in the rear region 10.1, the two catches 10.2 detach from the line connection block 6 and release the latter. The line connection block 6 can now be pulled off the injector housing 5 to the front (see FIG. 2). Advantageously, no tools are necessary to take off the line connection block 6. As soon as the line connection block 6 is removed, the system operator can pull the collection nozzle 8 out of the injector housing 5 to the front and can optionally clean it, check it for wear or replace it with a new collection nozzle, if need be. Advantageously, tools are also not necessary for the removal of the collection nozzle 8. The fastening of the line connection block 6 to the injector housing 5 also take place in a tool-free manner. For this purpose, the line connection block 6 is attached to the injector housing 5 with slight pressure, so that the two catches 10.2 snap into place on the line connection block 6. For this purpose, the line connection block 6 is in each case equipped with a groove 6.20 on both sides, with which the catch 10.2 of the closure clip 10 engages. The line connection block 6 is connected in a positive manner to the injector housing 5 in this way.

The injector housing 5 has a conveying air inlet 5.15, a fluidizing air inlet 5.16 and a metering air inlet 5.17. These inlets are also referred to as supply air inlets of the injector housing. The line connection block 6 has a conveying air connection 15 and a conveying air outlet 6.15; both are connected to one another via a channel. The line connection block 6 additionally has a fluidizing air connection 16 and a fluidizing air outlet 6.16, wherein the fluidizing air connection 16 is connected to the fluidizing air outlet 6.16 via a further channel. And lastly, the line connection block 6 also has a metering air connection 17 and a metering air outlet 6.17, wherein both are connected to one another via an additional channel. In the assembled state, the conveying air connection 15 is connected to the conveying air inlet 5.15 of the injector housing, the fluidizing air connection 16 is connected to the fluidizing air inlet 5.16 and the metering air connection 17 is connected to the metering air inlet 5.17. The conveying air outlet 6.15, the fluidizing air outlet 6.16 and the metering air outlet 6.17 will also be referred to below as supply air outlets of the line connection block 6.

Not only the line connection block 6 is fastened to the injector housing 5 with the help of the quick closure 9, but the supply air outlets 6.15, 6.16, 6.17 of the line connection block 6 are also connected to the supply air inlets 5.15, 5.16, 5.17 of the injector housing 5.

Advantageously, a spring 13 is located in the rear region 10.1 of the closure clip 10 between the closure clip and the injector housing 5. The spring 13 ensures that the closure clip 10 is permanently kept under tension. The catch 10.2 of the closure clip 10 only moves out of the groove 6.20 thereby when sufficient force is applied to the closure clip 10 on the rear. It is ensured thereby that the line connection block 6 does not inadvertently detach from the injector housing 5. Advantageously, the injector 2 is constructed so that both closure clips 10 are under tension. This can be attained, for example, in that a spring 13 is in each case arranged between injector housing 5 and closure clip 10 on both sides of the injector housing 5.

Advantageously, the quick closure 9 is formed so that the two closure clips 10 themselves are self-resetting. The spring 13, which applies pressure to the closure clip 10, can be provided for this purpose, so that said closure clip, after it was released, is turned back into its original position.

The point, at which pressure is to be applied to the closure clip 10, in order to release the line connection block 6, can be optically marked and/or can be formed so that it can be felt.

The closure clip 10 can have ribs in the rear section 10.1, where the gripping region is located. The ribs improve the grip for the fingers and suggest optically, where the closure clip is to be gripped and pressed.

In the case of one embodiment, the line connection block 6 and the injector housing 5 are equipped with a guide and a counter piece matching the guide, so that the line connection block 6 can be fastened to the injector housing 5 only in a single position. The installation is simplified thereby and an incorrect assembly is avoided. The guide with counter piece can be generated, for example, by means of a sleeve in the line connection block 6 and a matching bore in the injector housing 5. In the installed state, the sleeve protrudes into the bore.

In the case of the embodiment shown in the figures, the injector housing 5 is formed in two pieces and comprises an upper injector housing 5.1 and a lower injector housing 5.2. Advantageously, the upper injector housing 5.1 and the lower injector housing 5.2 can be connected to one another with the help of the two screws 14. This is advantageous, for example, because the two screws 14 then fulfill several tasks at the same time. On the one hand, they connect the upper and the lower injector housing 5.1 and 5.2 to one another. On the other hand, they hold the two closure clips 10 and lastly also serve as axes of rotation for the two closure clips 10.

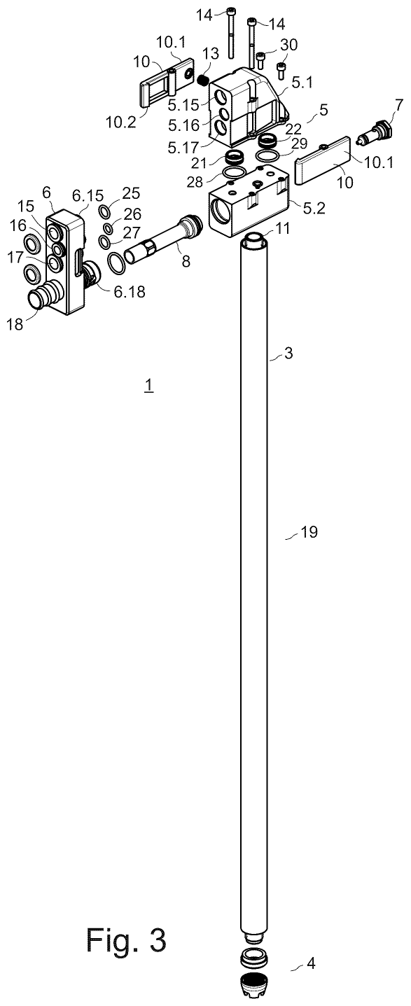

If need be, additional screws 30 can be provided (see FIG. 3), in order to connect the upper housing part 5.1 and the lower housing part 5.2 to one another.

In the case of the embodiment shown in the figures, the powder injector 2 also comprises, in addition to the collection nozzle 8, a drive nozzle 7, a powder inlet 12 and a powder hose connection 18, which forms the powder outlet of the injector.

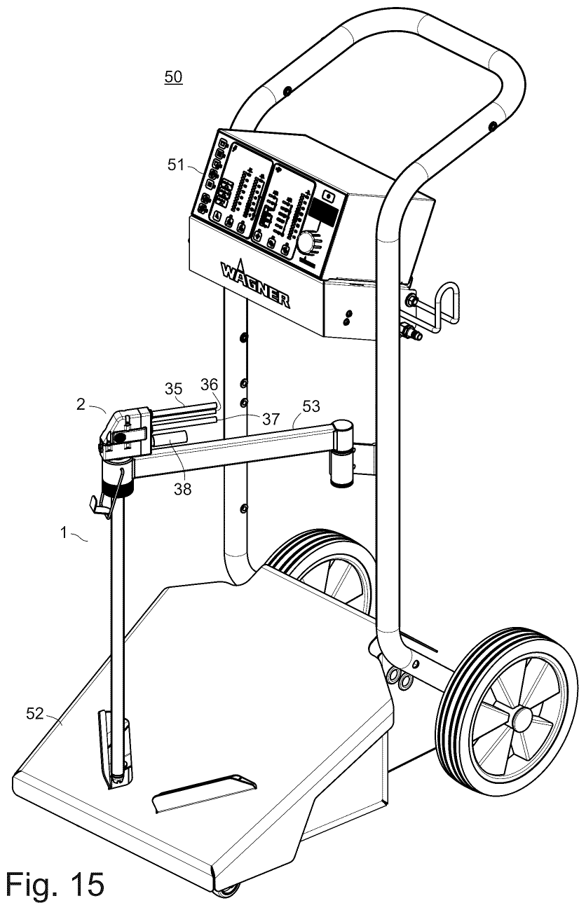

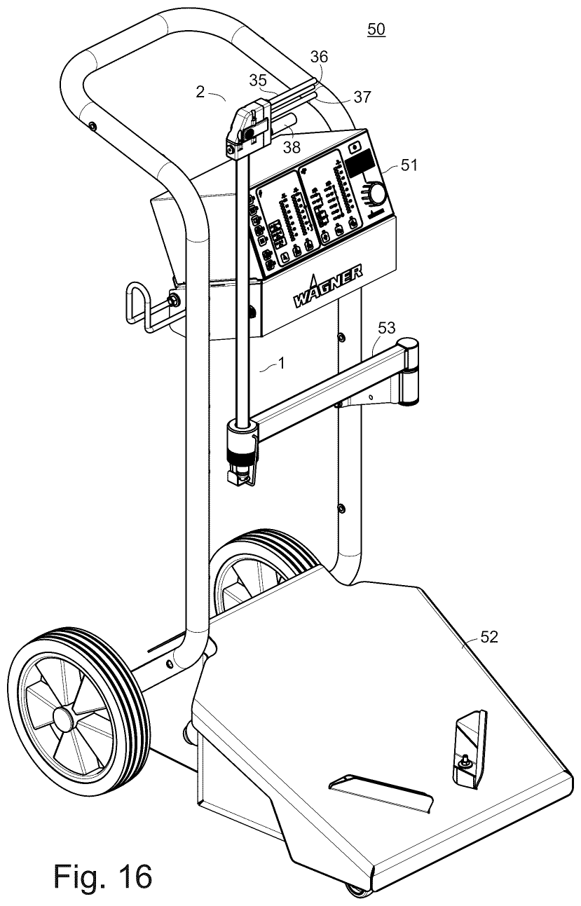

The powder inlet 12 of the injector 2 is connected to the intake pipe 3, for example via a screw or a plug connection. The powder outlet or powder hose connection 18, respectively, of the injector 2 is connected to a powder hose 38 (see FIGS. 15 and 16), via which the powder conveyed by means of the injector is transported to a spray applicator. Via the conveying air connection 15, conveying air TL is guided to the drive nozzle 7 via a channel 45. Via the metering air connection 17, metering air DL is guided via a channel 47 into a ring-shaped metering air channel, which is formed by the outer jacket surface of the collection nozzle 8 and the injector housing 5.

The drive nozzle 7 has a drive nozzle inlet for the conveying air and a drive nozzle outlet on its downstream end. Coming from the conveying air connection 15, the conveying air TL is guided into the drive nozzle 7 through the conveying air outlet 6.15, the conveying air inlet 5.15 and the conveying air channel 45. From there, the conveying air TL flows through the drive nozzle 7 and out of the drive nozzle outlet in the direction of the collection nozzle 8. While the conveying air TL flows to the collection nozzle 8, it generates a negative pressure in the intake pipe 3 and thus sucks the powder through the intake pipe 3 out of the storage container.

On its upstream end, the collection nozzle 8 has an opening with a defined radius, through which the powder, which has been taken in, flows into the collection nozzle 8. A channel section, which serves as mixing pipe, adjoins the opening. This, in turn, is adjoined by a conical channel section, which widens in the downstream direction and which is formed as diffusor. The powder hose connection 18 adjoins the downstream end of the collection nozzle 8. The upstream section of the collection nozzle 8 is arranged in the injector housing 5. The downstream section of the collection nozzle 8 protrudes into the line connection block 6 or through it.

The metering air DL flows into the powder line 38 through the metering air connection 17, the metering air outlet 6.17, the metering air inlet 5.17, the metering air channel 47 and a downstream metering air outlet. The downstream metering air outlet is located between the outer jacket surface of the collection nozzle 8 and the inner side of the powder hose connection 18. In the powder line 38, the metering air DL mixes with powder-conveying air mixture flowing out of the collection nozzle 8.

As illustrated in FIG. 3, seals 28 and 29 can be arranged between the upper injector housing 5.1 and the lower injector housing 5.2, in order to seal the channels 45 and 47 to the outside. The seals 28 and 29 are preferably O-rings or other axially acting seals.

In the case of one embodiment, a non-return valve 21 is arranged in the channel 47. In the case of a further embodiment, a non-return valve 22 is arranged in the channel 45. The non-return valve or the two non-return valves 21 and 22 are preferably equipped with an elastic disk, which serves as flexible closure. The non-return valves 21 and 22 are inserted into the upper injector housing 5.1. This is not mandatory, however, Instead, they can also be inserted into the lower injector housing 5.2.

The non-return valve 21 prevents that powder gets into the metering air line (supply air line) 47. Powder in the metering air line 47 is to be avoided because powder, which deposits there, can clog the metering air line 47.

The same applies analogously for the non-return valve 22. It prevents that powder gets into the conveying air line (supply air line) 45. Powder in the conveying air line 45 is to be avoided because powder, which deposits there, can clog it.

If the non-return valves 21 and 22 were not present, powder could additionally get via the air lines all the way to the regulating valves in the control housing and could damage them.

Seals 25, 26 and 27 are preferably arranged between the injector housing 5 and the line connection block 6, in order to seal the channels 45, 46 and 47 towards the outside, which guide the conveying air TL, the metering air DL and the fluidizing air FL. The seals 25, 26 and 27 are preferably formed as radially acting seal. They can be O-rings, for example.

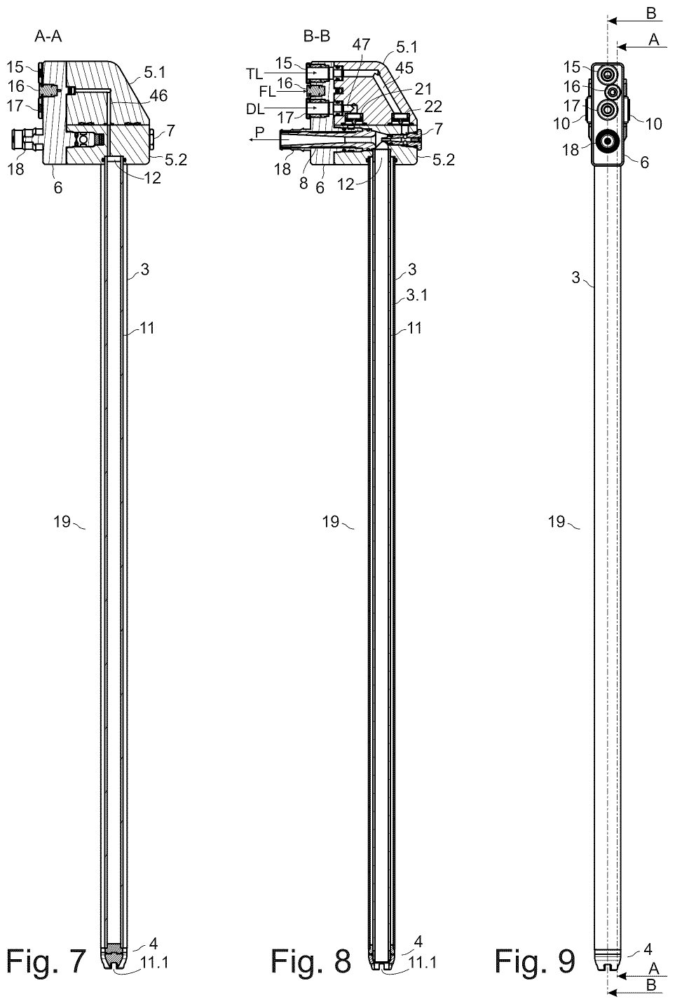

Fluidizing air FL flows into the injector 2 via the fluidizing air connection 16. The fluidizing air FL can be air or nitrogen, for example. As shown in FIG. 7, the fluidizing air FL gets from the fluidizing air connection 16 via a fluidizing air channel 46 into the powder lance 19, namely into the intermediate space between the intake pipe 11 and the pipe 3.

On the inlet side, the powder lance 19 has a fluidizing ring 4. On the outlet side, the intake pipe 11 of the powder lance 19 is connected to the powder inlet 12 of the powder injector 2.

The intake pipe 11 is dipped into the powder reservoir with the fluidizing ring 4 and the fluidizing ring 4 is supplied with fluidizing air FL, in order to fluidize the powder surrounding the fluidizing ring 4. The fluidized powder is sucked out of the powder reservoir with the help of the powder injector 2 via the intake pipe 11 and is transported to a powder applicator via a powder hose 38 (FIG. 15).

The fluidizing ring 4 has a ring made of a porous material, which can be, for example, a semi-permeable material, which is permeable for air. The fluidizing ring 4 can be made, for example, of POM, metal or sintered PE. In order to protect the fluidizing ring 4 against impacts, a protective ring can be arranged on its underside. The powder, which is present in the region of the fluidizing ring 4, is brought into a free-flowing state with the fluidizing air FL, which is guided through the fluidizing ring 4, which is referred to as fluidizing. Below the fluidizing ring 4, the intake pipe 11 has an intake opening 11.1, through which the fluidized powder can be sucked out of the storage container. In order to be able to control the fluidizing air FL, the manual system 50 can have a control 51.

The fluidizing ring 4 can be formed so that it defines the position of the intake pipe 3 with respect to the surrounding pipe 11.

The intake pipe 11 is preferably nickel-plated. This has the advantage that it can be cleaned more easily due to the nickel coating.

The powder lance 19 is preferably lowered so far into the powder storage container that the fluidizing ring 4 is located in the lower region of the powder storage container. The powder is fluidized in the lower region of the storage container in this way and it is prevented that the powder escapes on the top via the opening in the storage container and contaminates the surrounding area.

The intake pipe 11 is arranged in the pipe 3. A channel 3.1, which serves the purpose of guiding the fluidizing air FL downwards to the fluidizing ring 4, is created between the pipe 3 and the intake pipe 11 thereby. The channel 3.1 is also referred to as fluidizing air channel.

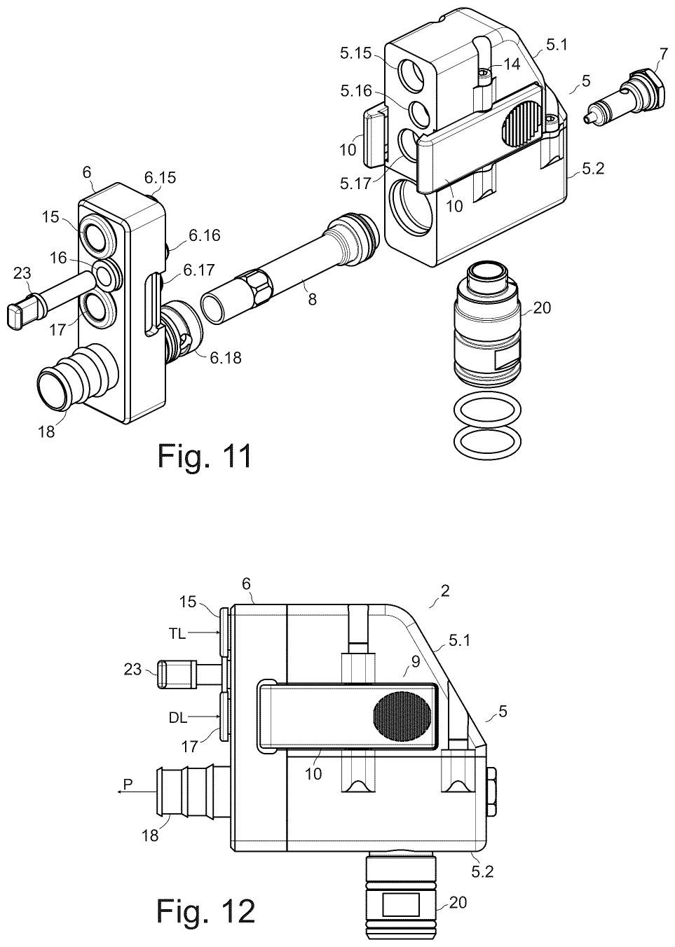

As illustrated in FIGS. 11 and 12, an adapter 20 can be provided on the inlet side of the injector 2, which adapter is arranged between the injector housing 5 and the intake pipe 3. The adapter 20 is advantageous in particular when the injector 2 is used, for example, for a 60 liter powder container (not shown in the figures). In the case of the 60 liter powder container, the fluidizing air line is connected directly on the side of the powder container bottom and the fluidizing air FL is guided into the powder container from there. The fluidizing air FL is thus not guided via the injector 2 in this case. In the case of the 60 liter powder container, the cover of the powder container has an adapter connection. On the underside of the adapter connection, the intake pipe 3 is connected to the adapter connection. On its top side, the adapter connection can be connected to the adapter 20. The adapter connection allows the adapter 20 and thus the injector 2 to be installed and removed easily.

If no fluidizing air FL is to be used, the fluidizing air connection 16 can be closed by means of a plug 23 (see FIGS. 11 and 12).

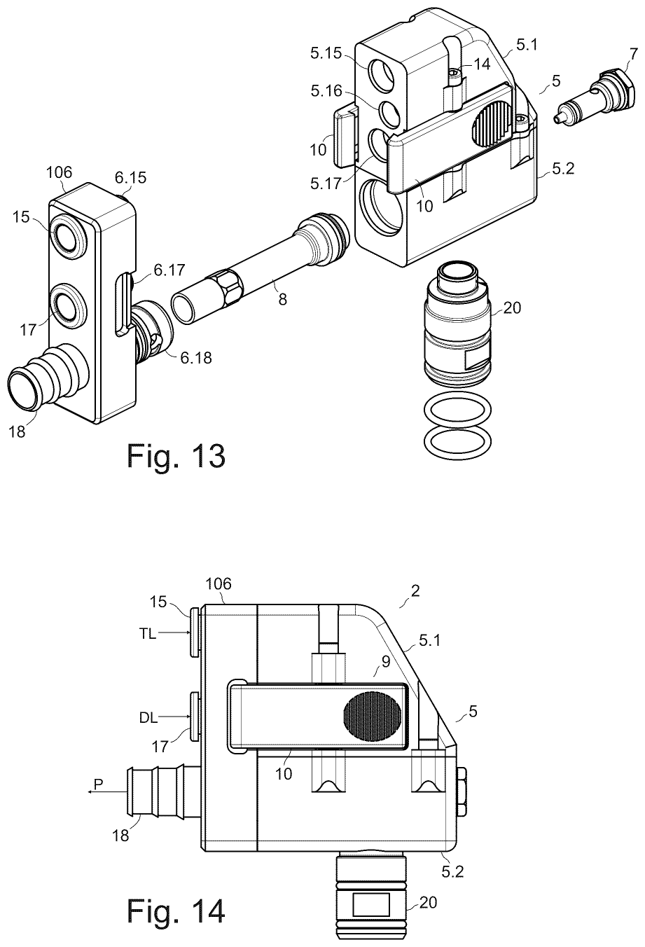

Instead, a slightly changed line connection block 106 can also be used (see FIGS. 13 and 14). In contrast to the line connection block 6, the line connection block 106 does not have a fluidizing air connection. Apart from that, the line connection block 106 is structurally identical to the line connection block 6.

The manual system 50 illustrated in FIGS. 15 and 16 is equipped with a storage surface 52, on which the powder storage container can be stored.

The manual system 50 can additionally have a vibrating device with a vibrating motor (not visible in the figures), in order to be able to put the storage surface 52 and thus the storage container in vibration. A powder-air mixture, which is even more homogenous, can be generated in the storage container thereby.

The powder conveyor 1 is held on a holding arm 53. It can be pivoted over the powder storage container with the help of the holding arm 53 and can be lowered into the container.

A conveying air line 35 can be connected to the conveying air connection 15, and a metering air line 37 can be connected to the metering air connection 17. It can be provided that the conveying air line 35 and the metering air line 37 are arranged in a hose. The cleaning effort can be reduced even further thereby because only the hose still has to be cleaned and not the conveying air line 35 as well as the metering air line 36.

The injector can be operated with air or other gases. The gas can be air or nitrogen. The conveying air, the metering air and/or the fluidizing air can thus be air or a different gas. To simplify matters, reference will only be made to air.

The preceding description of the exemplary embodiments according to the present invention only serves illustrative purposes. It goes without saying that various changes and modifications are possible. For example, the various components of the powder conveyor and of the manual system shown in FIGS. 1 to 16 can thus also be combined with one another in a different way than shown in the figures.

### LIST OF REFERENCE NUMERALS

1 powder conveyor
2 powder injector
3 pipe
3.1 fluidizing air channel
4 fluidizing ring
5 injector housing
5.1 upper injector housing/upper housing part
5.2 lower injector housing/lower housing part
5.15 supply air inlet/inlet for conveying air
5.16 supply air inlet/inlet for fluidizing air
5.17 supply air inlet/inlet for metering air
6 line connection block
6.15 supply air outlet/outlet for conveying air
6.16 supply air outlet/outlet for fluidizing air
6.17 supply air outlet/outlet for metering air
6.18 powder inlet
6.20 groove
7 drive nozzle
8 collection nozzle
9 quick closure
10 closure clip
10.1 rear section of the closure clip
10.2 catch
11 intake pipe
11.1 intake opening
12 powder inlet
13 spring
14 screw
15 conveying air connection
16 fluidizing air connection
17 metering air connection
18 powder hose connection
19 powder lance
20 adapter
21 non-return valve
22 non-return valve
23 plug
25 seal
26 seal
27 seal
28 seal
29 seal
30 screws
35 hose for conveying air
36 hose for fluidizing air
37 hose for metering air
38 powder hose
45 conveying air channel
46 fluidizing air channel
47 metering air channel
50 manual system
51 control
52 storage surface
53 holding arm
106 line connection block
FL fluidizing air
DL metering air
TL conveying air
P powder

1. A powder injector with quick coupling,
with an injector housing, which has a powder inlet and supply air inlets and in which a drive nozzle and a collection nozzle are arranged,
with a line connection block, which has connections for supply air lines and the supply air outlets and
with a quick closure, by means of which the line connection block can be fastened to the injector housing and the supply air outlets of the line connection block can be connected to the supply air inlets of the injector housing.

2. The powder injector according to patent claim 1, in the case of which the quick closure has a snap-in connection.

3. The powder injector according to patent claim 1, in the case of which the quick closure has a self-resetting closure clip.

4. The powder injector according to claim 1, in the case of which the line connection block comprises a powder hose connection, which forms the powder outlet of the powder injector.

5. The powder injector according to claim 1, in the case of which one of the connections of the line connection block is provided for the connection of a hose for conveying air.

6. The powder injector according to claim 1, in the case of which a further one of the connections of the line connection block is provided for the connection of a hose for metering air.

7. The powder injector according to claim 1, in the case of which a further one of the connections of the line connection block is provided for the connection of a hose for fluidizing air.

8. The powder injector according to claim 1, in the case of which the connections are arranged on one side of the line connection block.

9. The powder injector according to claim 1, with seals between the supply air outlets and the supply air inlets.

10. The powder injector according to patent claim 9, in the case of which the seals are formed as radially acting seals.

11. The powder injector according to claim 1, in the case of which the line connection block has a guide and the injector housing has a counter piece matching the guide.

12. The powder injector according to claim 1, with a non-return valve, which is arranged in the injector housing downstream from the supply air inlet.

13. The powder injector according to claim 3,
in the case of which the injector housing comprises an upper housing part and a lower housing part, and
with a connecting means, which connects the upper housing part and the lower housing part to one another, which forms the axis of rotation for the closure clip and which holds the closure clip.

14. The powder injector according to patent claim 13, in the case of which the connecting means is formed as screw.

15. The powder injector according to claim 1, in the case of which the injector housing is formed so that the collection nozzle can be pulled out of the injector housing when the line connection block is taken off.

16. A powder conveyor with a powder injector according to claim 1,
with an intake pipe, which is connected to the powder inlet of the powder injector,
with a pipe surrounding the intake pipe, and
with a fluidizing air line, which runs through the injector housing and which opens out into the pipe.

17. The powder conveyor according to patent claim 16, in the case of which the intake pipe has a thread on the outlet side and the injector housing has a matching counter thread.

18. The powder conveyor according to patent claim 16, with a fluidizing ring, which is connected to the pipe and which is provided to distribute fluidizing air in the powder supply.

19. The powder conveyor according to claim 16, in the case of which the fluidizing ring centers the intake pipe with respect to the pipe.
